(19) United States
(12) Patent Application Publication
(10) Pub. No.: US 2021/0178494 A1
(43) Pub. Date: Jun. 17, 2021

(54) DEVICE FOR MAKING AN OPENING IN AN OBJECT OF INTEREST

(71) Applicants: Shlomi NOAH, Petach Tikva (IL); Doron VEINSTEIN, Petach Tikva (IL); K.V. LTD., Petach Tikva (IL)

(72) Inventors: Tsachi DAVIDOV, Neve Monoson (IL); Amir LEVIT, Zoran (IL)

(21) Appl. No.: 17/268,453

(22) PCT Filed: Jan. 22, 2019
(86) PCT No.: PCT/IL2019/050088

§ 371 Date: Feb. 13, 2021

Related U.S. Application Data
(60) Provisional application No. 62/718,389, filed on Aug. 14, 2018.

(30) Foreign Application Priority Data
Aug. 14, 2018 (US) 62718389

(51) Int. Cl. B23C 1/20; B23C 9/00

(52) U.S. Cl. CPC B23C 1/20; B23C 2220/40; B23C 9/00

(57) ABSTRACT

A kit for making an aperture in an object of interest comprises: a hand-held tool configured for securing a milling cutter therewithin and a guiding member conformally shaped to the aperture. The guiding member is securable to a portion to be removed of the object of interest. the guiding member has a rim. The hand-held tool is provided with a bulge guidable by the rim such that such the milling cutter, when being manually movable along the rim, cuts the aperture in the object of interest.

### FIELD OF THE INVENTION

The present invention relates to devices for making openings in an object of interest and, more particularly, to devices for making openings of predetermined shape.

### BACKGROUND OF THE INVENTION

The known practice of making precise openings in thin materials such as sheets, walls or alike is the following. Boundaries of the openings are marked on a surface of the material. After that, at least one thru hole is made such that a fretsaw can be inserted into the hole. The desired opening is made by means of fret-cutting along the marked boundaries.

The abovementioned practice is a very time-consuming operation. In addition, this technology provides a high rate of defective goods. Thus, there is a long-felt and unmet need for a hand-held working tool providing a simple and reproducible technology of making openings of predetermined shape in any thin object of interest.

### SUMMARY OF THE INVENTION

It is hence one object of the invention to disclose a kit for making an aperture in an object of interest. The aforesaid kit comprises: (a) a hand-held tool configured for securing a milling cutter therewithin; the hand-held tool connectable to a rotational drive; (b) a guiding member conformally shaped to the aperture; the guiding member securable to a portion to be removed of the object of interest; the guiding member having a rim.

This is the purpose of the present invention to provide the hand-held tool with a bulge guidable by the rim such that such the milling cutter, when being manually movable along the rim, cuts the aperture in the object of interest.

Another object of the invention is to disclose the rotational drive which is a hand-held drill.

A further object of the invention is to disclose the hand-held tool comprising a housing having a handle for manually manipulating the hand-held tool, a driving member rotatably placed within the housing by means of at least one bearing; the driving member configured for connecting the milling cutter thereto.

A further object of the invention is to disclose the milling cutter connectable to the driving member by means of a threaded coupling.

A further object of the invention is to disclose the kit comprising a support member attachable to the hand-held tool; the support member having a bore configured for receiving the milling cutter in a coaxial manner; the support member has a first bulge and a second bulge arranged to support the hand-held tool when the first and second bulges are manually moved along the rim of the guiding member in physical contact with surfaces of the guiding member and the object of interest.

A further object of the invention is to disclose the bulge comprising a ball mountable in a rotatable manner; the ball is configured for rolling over the surfaces of the guiding member and the object of interest.

A further object of the invention is to disclose the object of interest selected from the group consisting of a mineral material, a polymeric material, an alloy material, a composite material and any combination thereof.

A further object of the invention is to disclose the mineral material which is gypsum.

A further object of the invention is to disclose a hand-held tool for making an aperture in an object of interest. The aforesaid hand-held tool configured for securing a milling cutter therewithin. The hand-held tool is connectable to a rotational drive.

A further purpose of the present invention is to provide a hand-held tool provided with a bulge guidable by a guiding member conformally shaped to the aperture.

A further object of the invention is to disclose the guiding member securable to a portion to be removed of the object of interest such that such the milling cutter, when being manually movable along the rim, cuts the aperture in the object of interest.

A further object of the invention is to disclose a method of making an aperture in an object of interest. The aforesaid method comprising steps of: (a) providing a kit for making an aperture in an object of interest; the kit comprising: (i) a hand-held tool configured for securing a milling cutter therewithin; the hand-held tool connectable to a rotational drive; (ii) a guiding member conformally shaped to the aperture; the guiding member securable to a portion to be removed of the object of interest the guiding member having a rim; the hand-held tool is provided with a bulge guidable by the rim such that such the milling cutter, when being manually movable along the rim, cuts the aperture in the object of interest; (b) providing the rotational drive; (c) connecting the driving member to the rotational drive; (d) threadedly securing the milling cutter in the driving member; (e) securing the guiding member in a selected location of making the opening in the object of interest; (f) manually moving the hand-held tool such that such the milling cutter cuts the aperture in the object of interest.

A further object of the invention is to disclose a device for making an opening in an object of interest comprising: (a) a base member; (b) attaching means configured for releasably attaching the base member to the object of interest: (c) a guiding member shaped conformally to the opening to be made: the guiding member having a guide way; the guiding member releasably connectable to the base member: (d) a slider movable along the guide way; and (e) cutting means securable within the slider and movable around the guiding member.

A further object of the invention is to disclose a method of making an opening in an object of interest: the method comprising steps of: (a) providing a device for making an opening in an object of interest further comprising: (i) a base member (ii) attaching means configured for releasably attaching the base member to the object of interest; (iii) a guiding member shaped conformally to the opening to be made; the guiding member having a guide way; the guiding member releasably connectable to the base member: (iv) a slider movable along the guide way; and (v) cutting means securable within the slider and movable around the guiding member; (b) releasably attaching the base member to the object of interest by the attaching means; (c) cutting the object of interest by moving the cutting means around the guiding member; (d) taking the device out of the object of interest with a cut portion of the object of interest; (e) removing the cut portion of the object of interest from the device.

A further object of the invention is to disclose a device for making an opening in an object of interest comprising: (a) a plate member having a guiding recess shaped conformally to the opening to be made; (b) attaching means configured for releasably attaching the plate member to the object of interest; (c) cutting means securable movable along the guiding recess.

A further object of the invention is to disclose a method of making an opening in an object of interest comprising steps of: (a) providing a device for making an opening in an object of interest further comprising: (i) a plate member having a guiding recess shaped conformally to the opening to be made; (ii) attaching means configured for releasably attaching the plate member to the object of interest; (iii) cutting means securable movable along the guiding recess; (b) releasably attaching the plate member to the object of interest by the attaching means; (c) cutting the object of interest by moving the cutting means along the guiding recess; (d) taking the device out of the object of interest with a cut portion of the object of interest; (e) removing the cut portion of the object of interest from the device.

A further object of the invention is to disclose a device for making an opening in an object of interest. The aforesaid device comprises: (a) a member shaped conformally to the opening to be made; the member having a first side and a second side; (b) an area element connected to the first side and configured for applying a force driving the device into the object of interest; and (c) a serrated profile connected to the second side.

A further object of the invention is to disclose the device comprising a carrying handle.

A further object of the invention is to disclose the device comprising at least one bracket for taking the device out of the object of interest by means of a lever after driving the device into the object of interest.

A further object of the invention is to disclose the device comprising a bearing member placeable onto the object of interest. The bearing member is configured for supporting the lever.

A further object of the invention is to disclose the method of making an opening in an object of interest. The aforesaid method comprises steps of: (a) providing a device for making an opening in an object of interest further comprising: (i) a member shaped conformally to the opening to be made; the member having a first side and a second side; (ii) an area element connected to the first side and configured for applying a force driving the device into the object of interest; (iii) a serrated profile connected to the second side; (b) driving the device into the object of interest such that a portion of the object of interest within the device is cut from the object of interest; (c) taking the device out of the object of interest with a cut portion of the object of interest; (d) removing the cut portion of the object of interest from the device.

A further object of the invention is to disclose the method comprising a step of carrying the device by means of a carrying handle.

A further object of the invention is to disclose the step of taking the device out of the object of interest performed by at least one bracket and a lever.

A further object of the invention is to disclose the step of taking the device out of the object of interest comprising supporting the lever by a bearing member placeable onto the object of interest.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a general view of a kit for making an aperture in an object of interest;

FIG. 2 is a side view of a kit for making an aperture in an object of interest;

FIG. 3 is a cross-sectional view of a kit for making an aperture in an object of interest;

FIG. 4 is a perspective view of a device for making an opening in an object of interest provided with a guide way;

FIGS. 5a to 5c are perspective views of a base member, an attaching means and a slider, respectively;

FIG. 5d is a cross-sectional view of a device for making an opening in an object of interest provided with a guide way;

FIGS. 6a to 6d illustrate a method of making an opening in an object of interest using a device with a guide way;

FIG. 7 illustrates attaching device for making an opening to an object of interest by a screw; and

FIGS. 8a and 8b illustrate a method of making an opening in an object of interest using a device with a guide recess; and

FIGS. 9a to 9c are schematic views of a device for making an opening in an object of interest provided with a serrated profile.

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a kit for making an opening in an object of interest and a method of doing the same.

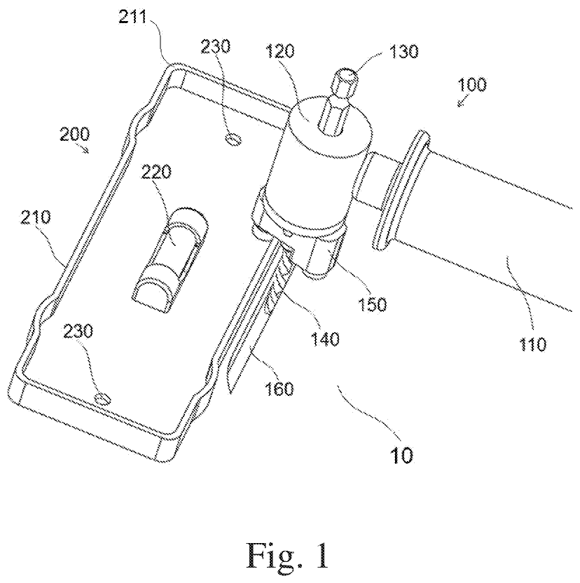

Reference is now made to FIG. 1 presenting a general view of a kit for making an aperture in an object of interest. The aforesaid kit comprises hand-held tool 100 and guiding member 200. Specifically, hand-held tool is manipulated by means of handle 110 grippable by a user. Driving member 130 is mechanically connectable to a rotational drive (not shown) by, for example, by securing driving member 130 in a chuck of a hand-held drill. Driving member 130 is rotationally placed within housing 120. The aforesaid housing 120 is supported by supporting member 150 movable along rim 210 of guiding member 200. In an exemplary embodiment of the present invention, guiding member 200 is securable to surface 10 of an object of interest in a location of making an opening by commercially available screws (not shown) via holes 230. Numeral 220 refers a spirit level for horizontalizing guiding member 200 before securing to surface 10.

As mentioned above, a user moves hand-held tool 100 along rim 210 such that milling cutter 140 cuts slotted opening 160 around guiding member 200. Geometries of rim 210 and slotted opening 160 are conformal to each other. A trajectory of movement hand-tool 100 follows rim 210. Curvature of opening corners 211 to be made can go to zero. In other words, available opening corners are near to right.

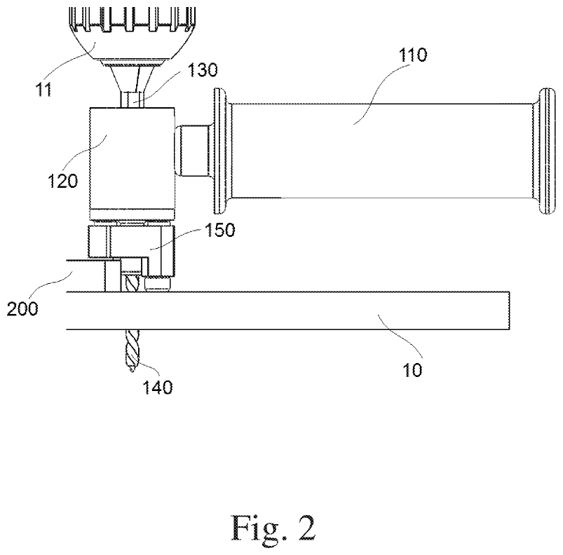

Reference is now made to FIG. 2 presenting a side view of a kit for making an aperture in an object of interest. Driving member 130 is secured in chuck 11 of a hand-held drill.

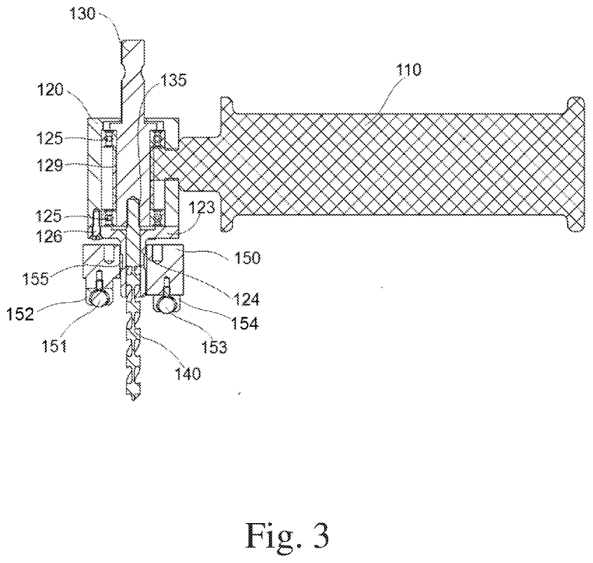

Reference is now made to FIG. 3 presenting a cross-sectional view of a kit for making an aperture in an object of interest. Milling cutter 140 is threadedly secured to driving member 130. As mentioned above, driving member 130 is rotatably placed within housing 120 by means of ball bearings 125. Numeral 129 refers to a sleeving placed on driving member 130. The aforesaid driving member rests on bottom member 123 secured to housing 120 by screw 126. Bottom member 123 has projecting tubular portion 124 insertable into bore 155 of support member 150. Bore is configured for receiving milling cutter 140 in a coaxial manner. Support member 150 has first bulge 152 and second bulge 154 arranged to support the hand-held tool 100 when first and second bulges 152 and 154 are manually moved along the rim of the guiding member in physical contact with surfaces of the guiding member 200 and the object of interest 10. According to one embodiment of the present invention, first and second bulges 152 and 154 are provided with balls 151 and 153 rotatably mounted within first and second bulges 152 and 154, respectively. According to one embodiment of the present invention, support member 150 is attachable to housing 100 by embedded magnets (not shown).

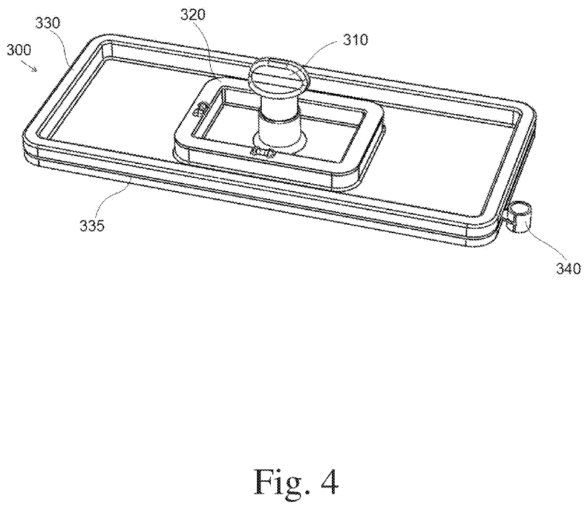

Reference is now made to FIG. 4 showing embodiment 300 of the present invention. Device 200 comprises base member 320 which is attachable to an object of interest (not shown) by attaching means 310 such as a screw. Securing the device to the object of interest by one or several screws is in the scope of the present invention. Guiding member 330 is shaped conformally to the opening to be made and provided with guide way 335.

A plurality of replaceable guiding members for making openings with different form factors is in the scope of the present invention. Slider 340 is movable within guide way 335 such that cutting means 350 secured to slider 340 is movable around the guiding member 330. Numeral 360 refers to a tool such as milling drill configured for cutting both in axial and transversal directions.

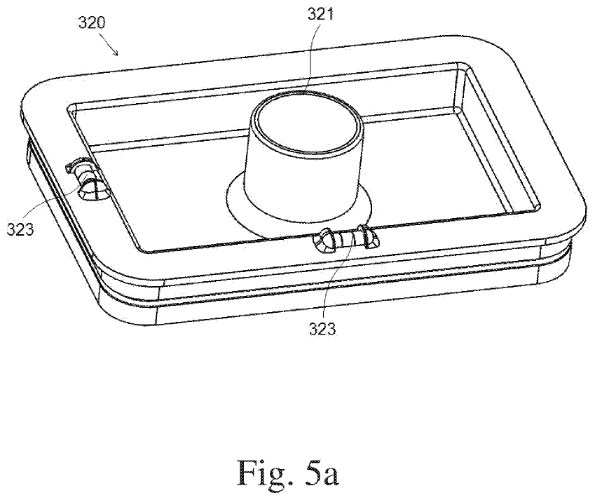

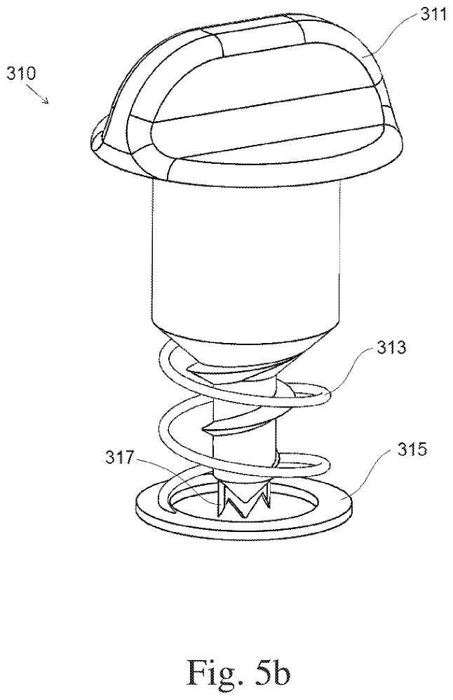

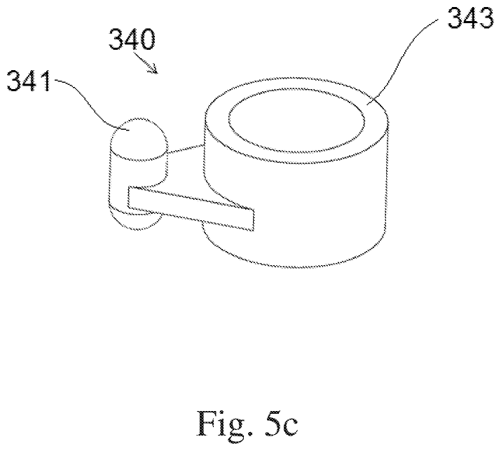

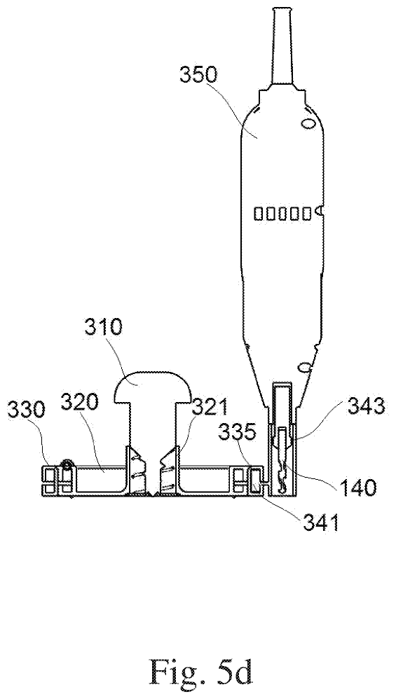

Reference is now made FIGS. 5a to 5c showing the components of device 300. Specifically, FIGS. 5a to 5c present a base member, an attaching means and a slider, respectively. Base member has through bore 321 configured for receiving attaching means (not shown). Numeral 323 refers to a level tube. Attaching means 310 comprises handle 311 and spring 311 provided with abutment 315. Screw 317 is configured to be secured within object of interest (not shown). Slider 340 comprises projection 341 movable within the guide way (not shown) and tubal member 343 configured for carrying cutting means (not shown).

Reference is now made to FIG. 5d showing a cross-sectional view of device 300. Attaching means 310 is inserted into through bore 321 of base member 320 such that the abovementioned base member is attachable to an object of interest (not shown). Cutting means 350 is secured within tubal member 343 while projection 341 is movable within guide way 335.

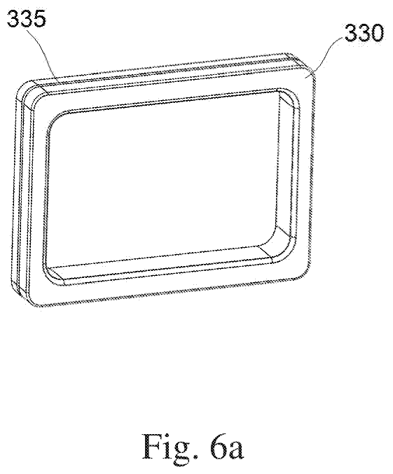

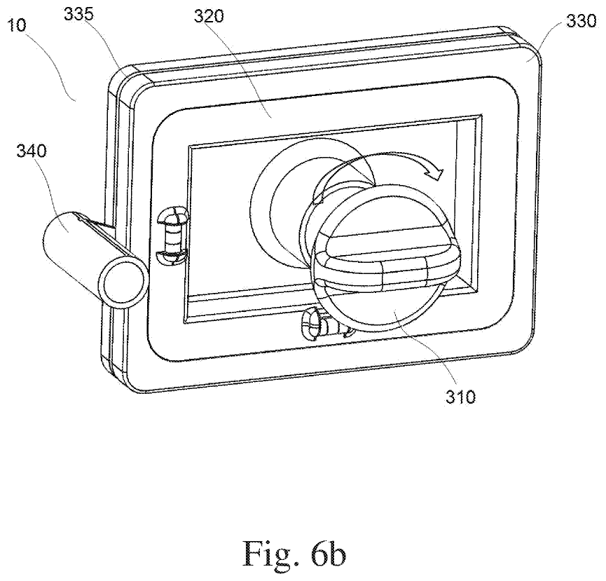

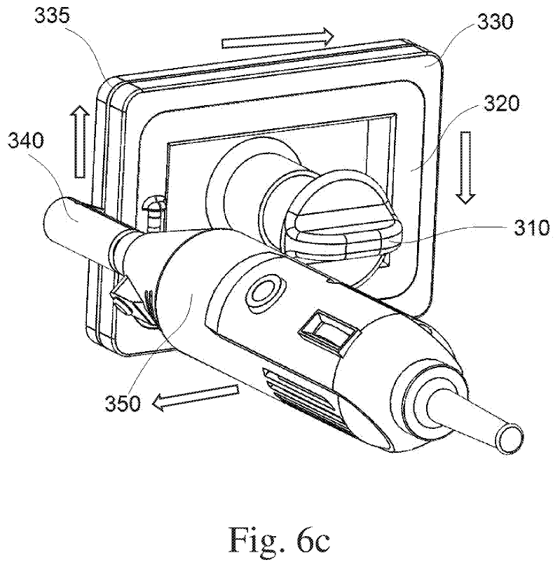

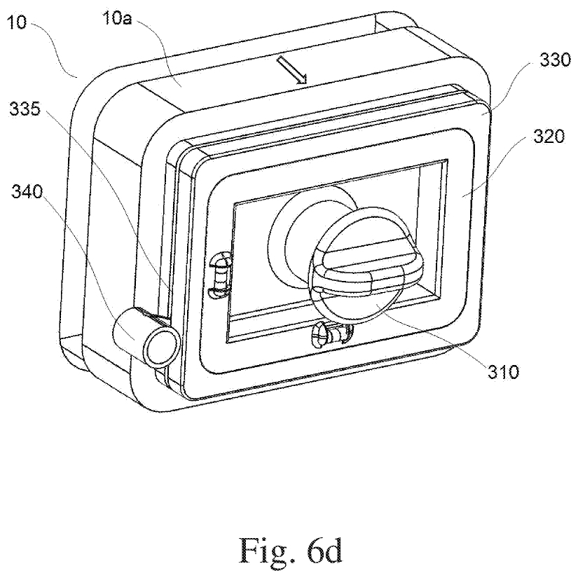

Reference is now made to FIGS. 6a to 6d illustrating a procedure of making an opening in an object of interest.

Specifically, at the first step (FIG. 6a), guiding member 330 conformal to an opening to be made is chosen. Then, guiding member 330 is connected to base member 320. The obtained assembly is attached to object of interest 10 by attaching means 310 (FIG. 6b). A user rotates a handle and drives a screw (not shown) into object of interest 10. The opening is cut within object of interest 10 by moving cutting means 350 carried by slider 340 about guiding member 330 (FIG. 6c). As cutting means, a standard hand drill can be used while cutting tool 360 is defined as a milling drill configured for cutting both in axial and transversal directions also know in the art. After cutting up the desired opening, the device is taken out of object of interest 10 with cut portion 10a (FIG. 6d) which is removed from the device manually.

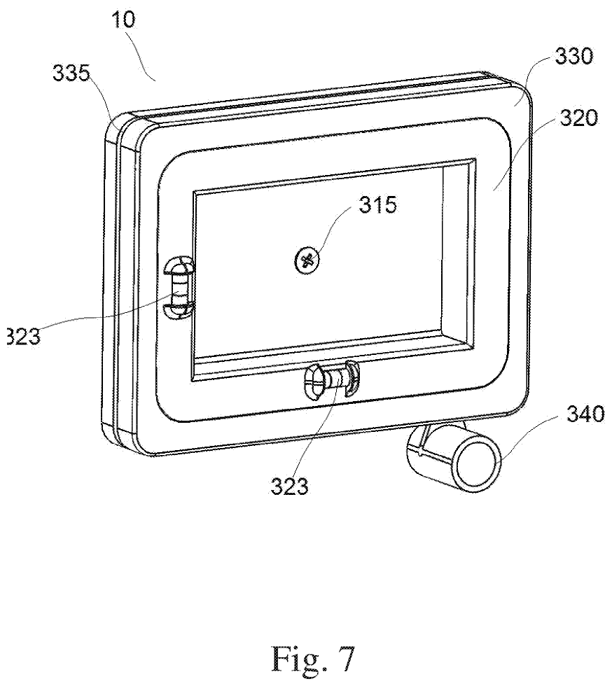

Reference is now made to FIG. 7 showing an alternative embodiment of the present invention. The device is attached to object of interest 10 by commercially available screw 315.

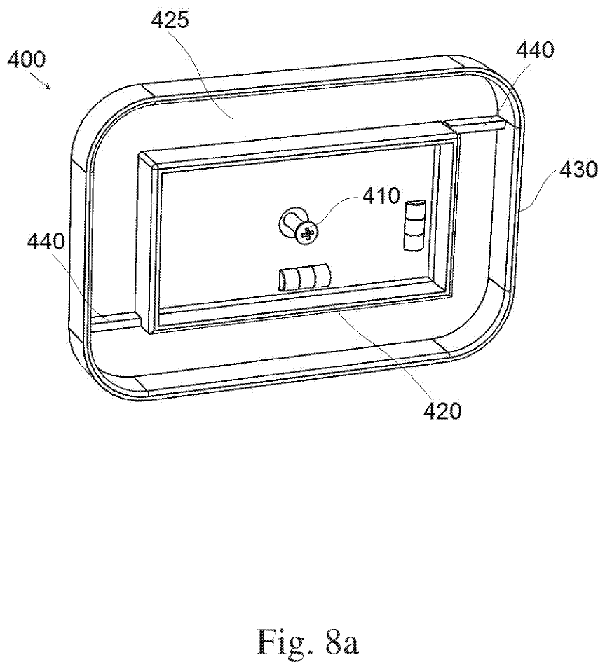

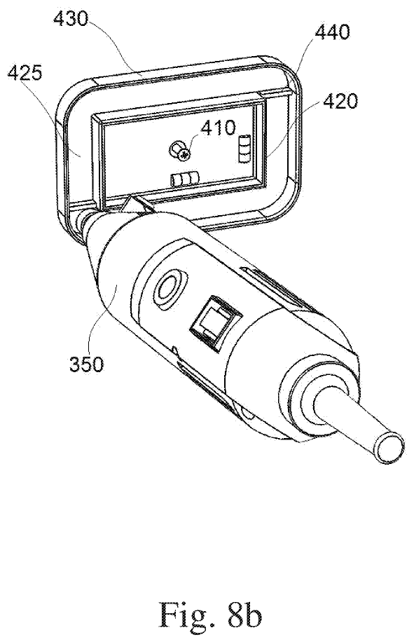

Reference is now to FIGS. 8a and 8b showing a further embodiment of the present invention. Specifically, device 400 comprises plate member 420 having guiding recess 425 shaped conformally to the opening to be made. Device 400 is releasably attachable to object of interest 10 by attaching means 415. Cutting means 350 is movable along guiding recess 425. Numerals 430 and 440 refer to an external rim of plate member 420 and spacers defining guiding recess 425. With reference to FIG. 8b, the opening is cut up by moving cutting means 350 along recess 425.

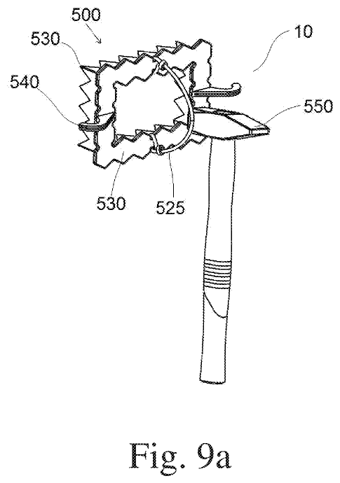

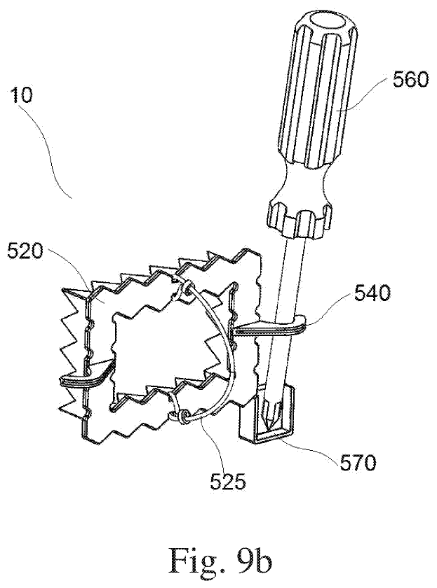

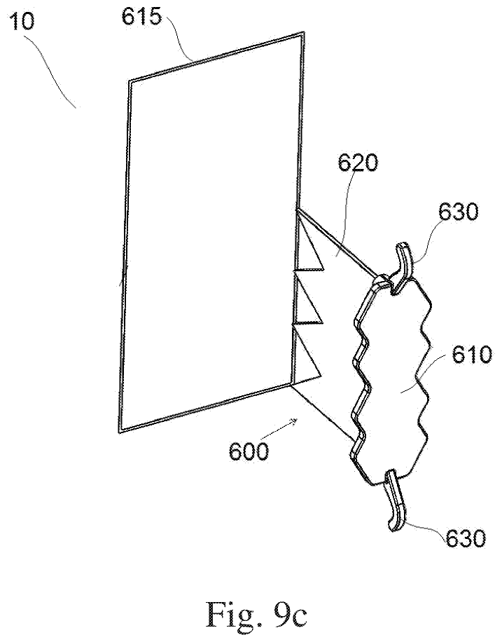

Reference is now made to FIGS. 9a to 9c presenting device 500 for making an opening in an object of interest. According to one embodiment of the present invention, device 500 is shaped in a conformal manner in relative to an opening to be made. Device 500 is driven into object of interest 10 such as a wall in a building. A driving force can be applied to device 500 by a tool of an impact type such as hammer 550. Driving impacts of hammer 550 are applied to face 520. Serrated profile 530 is configured for entering into object of interest 10. Bracket 540 is designed for taking device 500 out of object of interest 10 by means of lever 560. Bearing member 570 is used for supporting the lever Numeral 525 refers to a carrying handle. After taking device 500 out of object of interest 10, cut portion is removed from device 500.

FIG. 9c shows a linear embodiment 600 of the present invention. Opening 615 is previously marked on object of interest 10. Opening 615 is cut up by device 600 successively along a perimeter of opening 615.

According to the present invention, a kit for making an aperture in an object of interest is disclosed. The aforesaid kit comprises: (a) a hand-held tool configured for securing a milling cutter therewithin: the hand-held tool connectable to a rotational drive: (b) a guiding member conformally shaped to the aperture; the guiding member securable to a portion to be removed of the object of interest: the guiding member having a rim.

This is the core feature of the present invention to provide the hand-held tool with a bulge guidable by the rim such that such the milling cutter, when being manually movable along the rim, cuts the aperture in the object of interest.

According to one embodiment of the present invention, the rotational drive is a hand-held drill.

According to another embodiment of the present invention, the hand-held tool comprises a housing having a handle for manually manipulating the hand-held tool, a driving member rotatably placed within the housing by means of at least one bearing; the driving member configured for connecting the milling cutter thereto.

According to a further embodiment of the present invention, the milling cutter is connectable to the driving member by means of a threaded coupling.

According to a further embodiment of the present invention, the kit comprises a support member attachable to the hand-held tool: the support member having a bore configured for receiving the milling cutter in a coaxial manner; the support member has a first bulge and a second bulge arranged to support the hand-held tool when the first and second bulges are manually moved along the rim of the guiding member in physical contact with surfaces of the guiding member and the object of interest.

According to a further embodiment of the present invention, the bulge comprises a ball mountable in a rotatable manner; the ball is configured for rolling over the surfaces of the guiding member and the object of interest.

According to a further embodiment of the present invention, the object of interest is selected from the group consisting of a mineral material, a polymeric material, an alloy material, a composite material and any combination thereof.

According to a further embodiment of the present invention, the mineral material is gypsum.

According to a further embodiment of the present invention, a hand-held tool for making an aperture in an object of interest is disclosed. The aforesaid hand-held tool configured for securing a milling cutter therewithin. The hand-held tool is connectable to a rotational drive.

A further core feature of the present invention is to provide a hand-held tool provided with a bulge guidable by a guiding member conformally shaped to the aperture.

According to a further embodiment of the present invention, the guiding member is securable to a portion to be removed of the object of interest such that such the milling cutter, when being manually movable along the rim, cuts the aperture in the object of interest.

According to a further embodiment of the present invention, a method of making an aperture in an object of interest comprises steps of: (a) providing a kit for making an aperture in an object of interest: the kit comprising: (i) a hand-held tool configured for securing a milling cutter therewithin; the hand-held tool connectable to a rotational drive; (ii) a guiding member conformally shaped to the aperture; the guiding member securable to a portion to be removed of the object of interest; the guiding member having a rim; the hand-held tool is provided with a bulge guidable by the rim such that such the milling cutter, when being manually movable along the rim, cuts the aperture in the object of interest; (b) providing the rotational drive; (c) connecting the driving member to the rotational drive: (d) threadedly securing the milling cutter in the driving member; (e) securing the guiding member in a selected location of making the opening in the object of interest; (f) manually moving the hand-held tool such that such the milling cutter cuts the aperture in the object of interest.

According to a further embodiment of the present invention, a device for making an opening in an object of interest comprises: (a) a base member; (b) attaching means configured for releasably attaching the base member to the object of interest: (c) a guiding member shaped conformally to the opening to be made; the guiding member having a guide way; the guiding member releasably connectable to the base member; (d) a slider movable along the guide way; and (e) cutting means securable within the slider and movable around the guiding member.

According to a further embodiment of the present invention, a method of making an opening in an object of interest is disclosed. The method comprises steps of: (a) providing a device for making an opening in an object of interest further comprising: (i) a base member; (ii) attaching means configured for releasably attaching the base member to the object of interest; (iii) a guiding member shaped conformally to the opening to be made: the guiding member having a guide way; the guiding member releasably connectable to the base member; (iv) a slider movable along the guide way: and (v) cutting means securable within the slider and movable around the guiding member; (b) releasably attaching the base member to the object of interest by the attaching means; (c) cutting the object of interest by moving the cutting means around the guiding member; (d) taking the device out of the object of interest with a cut portion of the object of interest; (e) removing the cut portion of the object of interest from the device.

According to a further embodiment of the present invention, a device for making an opening in an object of interest comprises: (a) a plate member having a guiding recess shaped conformally to the opening to be made; (b) attaching means configured for releasably attaching the plate member to the object of interest; (c) cutting means securable movable along the guiding recess.

According to a further embodiment of the present invention, a method of making an opening in an object of interest comprises steps of: (a) providing a device for making an opening in an object of interest further comprising: (i) a plate member having a guiding recess shaped conformally to the opening to be made; (ii) attaching means configured for releasably attaching the plate member to the object of interest: (iii) cutting means securable movable along the guiding recess; (b) releasably attaching the plate member to the object of interest by the attaching means; (c) cutting the object of interest by moving the cutting means along the guiding recess: (d) taking the device out of the object of interest with a cut portion of the object of interest: (e) removing the cut portion of the object of interest from the device.

According to a further embodiment of the present invention, a device for making an opening in an object of interest is disclosed. The aforesaid device comprises: (a) a member shaped conformally to the opening to be made; the member having a first side and a second side; (b) an area element connected to the first side and configured for applying a force driving the device into the object of interest; and (c) a serrated profile connected to the second side.

According to a further embodiment of the present invention, the device comprises a carrying handle.

According to a further embodiment of the present invention, the device comprises at least one bracket for taking the device out of the object of interest by means of a lever after driving the device into the object of interest.

According to a further embodiment of the present invention, the device comprises a bearing member placeable onto the object of interest. The bearing member is configured for supporting the lever.

According to a further embodiment of the present invention, the method of making an opening in an object of interest is disclosed. The aforesaid method comprises steps of: (a) providing a device for making an opening in an object of interest further comprising: (i) a member shaped conformally to the opening to be made; the member having a first side and a second side: (ii) an area element connected to the first side and configured for applying a force driving the device into the object of interest; (iii) a serrated profile connected to the second side; (b) driving the device into the object of interest such that a portion of the object of interest within the device is cut from the object of interest; (c) taking the device out of the object of interest with a cut portion of the object of interest; (d) removing the cut portion of the object of interest from the device.

According to a further embodiment of the present invention, the method comprises a step of carrying the device by means of a carrying handle.

According to a further embodiment of the present invention, the step of taking the device out of the object of interest is performed by at least one bracket and a lever.

According to a further embodiment of the present invention, the step of taking the device out of the object of interest comprises supporting the lever by a bearing member placeable onto the object of interest.

1.-42. (canceled)

43. A kit for making an aperture in an object of interest; said kit comprising:
a. a hand-held tool configured for securing a milling cutter therewithin; said hand-held tool connectable to a rotational drive;
b. a guiding member conformally shaped to said aperture; said guiding member securable to a portion to be removed of said object of interest; said guiding member having a rim;
wherein said hand-held tool is provided with a bulge guidable by said rim such that such said milling cutter, when being manually movable along said rim, cuts said aperture in said object of interest.

44. The kit according to claim 43, wherein said rotational drive is a hand-held drill.

45. The kit according to claim 43, wherein said hand-held tool comprises a housing having a handle for manually manipulating said hand-held tool, a driving member rotatably placed within said housing by means of at least one bearing; said driving member configured for connecting said milling cutter thereto.

46. The kit according to claim 43, wherein said milling cutter is connectable to said driving member by means of a threaded coupling.

47. The kit according to claim 43 comprising a support member attachable to said hand-held tool; said support member having a bore configured for receiving said milling cutter in a coaxial manner; said support member has a first bulge and a second bulge arranged to support said hand-held tool when said first and second bulges are manually moved along said rim of said guiding member in physical contact with surfaces of said guiding member and said object of interest.

48. The kit according to claim 47, wherein said bulge comprises a ball mountable in a rotatable manner; said ball is configured for rolling over said surfaces of said guiding member and said object of interest.

49. The kit according to claim 43, wherein said object of interest is selected from the group consisting of a mineral material, a polymeric material, an alloy material, a composite material and any combination thereof.

50. The kit according to claim 49, wherein said mineral material is gypsum.

51. A hand-held tool for making an aperture in an object of interest configured for securing a milling cutter therewithin; said hand-held tool connectable to a rotational drive; wherein said hand-held tool is provided with a bulge guidable by a guiding member conformally shaped to said aperture; said guiding member securable to a portion to be removed of said object of interest such that such said milling cutter, when being manually movable along said rim, cuts said aperture in said object of interest.

52. The kit according to claim 51, wherein said rotational drive is a hand-held drill.

53. The kit according to claim 51, wherein said hand-held tool comprises a housing having a handle for manually manipulating said hand-held tool, a driving member rotatably placed within said housing by means of at least one bearing; said driving member configured for connecting said milling cutter thereto.

54. The kit according to claim 51, wherein said milling cutter is connectable to said driving member by means of a threaded coupling.

55. The kit according to claim 51 comprising a support member attachable to said hand-held tool; said support member having a bore configured for receiving said milling cutter in a coaxial manner; said support member has a first bulge and a second bulge arranged to support said hand-held tool when said first and second bulges are manually moved along said rim of said guiding member in physical contact with surfaces of said guiding member and said object of interest.

56. The kit according to claim 55, wherein said bulge comprises a ball mountable in a rotatable manner; said ball is configured for rolling over said surfaces of said guiding member and said object of interest.

57. The kit according to claim 51, wherein said object of interest is selected from the group consisting of a mineral material, a polymeric material, an alloy material, a composite material and any combination thereof.

58. The kit according to claim 57, wherein said mineral material is gypsum.

59. A device for making an opening in an object of interest; said device comprising:
a. a base member;
b. attaching means configured for releasably attaching said base member to said object of interest;
c. a guiding member shaped conformally to a said opening to be made; said guiding member having a guide way; said guiding member releasably connectable to said base member;
d. a slider movable along said guide way; and
e. cutting means securable within said slider and movable along said guiding member.

60. The device according to claim 59, wherein said attaching means is at least one screw threadable into said object of interest.

61. The device according to claim 59, wherein said cutting means is a milling drill.

62. The device according to claim 59, wherein said milling drill is movable manually.
